(19) United States
(12) Patent Application Publication
(10) Pub. No.: US 2007/0055673 A1
(43) Pub. Date: Mar. 8, 2007

(54) Verified personal credit search system and method thereof

(76) Inventor: Neal King Rieffanaugh JR., Los Angeles, CA (US)

Correspondence Address: Raymond Y. Chan, 108 N. Ynez Ave., #128, Monterey Park, CA, 91754, US

(21) Appl. No.: 11/222,117

(22) Filed: Sep. 7, 2005

(51) Int. Cl. G06F 17/30

(52) U.S. Cl. 707/10

(57) ABSTRACT

A verified personal credit search system includes an information center, a credit terminal and an enquiring station. The information center includes a personal database for storing a plurality of personal records of candidates, wherein each of the personal records contains a plurality of personal qualities. The credit terminal which includes a credit database linked to the personal database for updating personal credits of the candidates respectively through a communication network, wherein the credit terminal receives each of the personal credits provided by a person related to the respective candidate for verifying an acknowledgment thereof as a personal reference.

### BACKGROUND OF THE PRESENT INVENTION

1. Field of Invention

The present invention relates to a search system, and more particularly to a verified personal credit search system and a method thereof which enables a user to obtain and confirm verified personal credits of a candidate.

2. Description of Related Arts

Credits are historical performances and records of a person or an entity. The financial credits of a person or an entity determine whether the person or the entity can obtain a loan or mortgage from a bank or lender. Reputation and public praise of common kinds of credit especially to a person like professional, politician, entertainment artist such as musician and actor, designer or to an entity like profession firm, builder, contactor, hospital, jewelry store. That is why People rely on referral by a reliable friend rather than yellow pages when they need a service provider.

All kinds of personal or entity service provider or applicant will provide resumes or advertisement brochures to claim their credential performances. However, it is very troublesome and difficult to verify whether the creditable information directly provided by the service providers or applicants are truth or not or reliable or not.

Also, independent service providers are located everywhere. You may have an excellence matching candidate to your service need couple yards away from you but you have no means to reach him or her. Even though you have an offer applicant submitting a resume to apply for your job offer, the most common way to verify the credential information provided in the resume of the applicant is to physically call up or to mail to the applicant's ex-employers for verification what you concern about the applicant.

Nowadays, there are some databases for storing personal records and entity information such as the electronic yellow pages which is a search engine usually comprises an information center maintaining a central database linked to the Internet. A user of the search engine is adapted to send search request to the information center which will then try to fulfill the search request by matching the relevant data stored in the central database. Conventionally, the search engine is extensively used for a wide variety of purposes, the least of which consists of commercial purpose, industrial purpose, or domestic purpose.

Same problem with this conventional practice is that the user who checks the credentials of the candidate does not know the accuracy or reliability of the information as contained in the central database. For example, when the user of the conventional search system is looking for an independent contractor for interior design or decoration, he may obtain some general information from the central database, but the user does not know any past experience or performance of the independent contractor. As a result, the user can only rely on superficial information about a particular contractor as shown in the database.

Likewise, when a particular employer wants to hire someone to fill a particular post, that employer may access the relevant information by sending a search request through the Internet. The search result may contain a number of resumes which detail the personal information, past work experience or achievements with respect to the relevant candidates. Again, the problem here is reliability and/or accuracy. Presumably, the information contained in the resumes is voluntarily provided by the candidates concerned without being verified. Consequently, for those who are seeking employment or independent contracts, they will dress up their credentials as perfect as possible so as to maximize their bargaining power for obtaining the maximum salary or the most attractive job offers.

### SUMMARY OF THE PRESENT INVENTION

A main object of the present invention is to provide a verified personal credit search system and a method thereof which enables a user to obtain and confirm the personal credits of a candidate so as to assist the user in making accurate decisions in a wide variety of transactions, such as various business transactions.

Another object of the present invention is to provide a verified personal credit search system and a method thereof, wherein entry of personal credits of a registered candidate is only allowed for a limited class of credit providers who have substantial relationship with the corresponding candidate. Therefore, an accuracy and reliability of the personal credits stored in a credit database of the present invention with respect to the relevant candidate can be ensured.

Another object of the present invention is to provide a verified personal credit search system and a method thereof, which utilize electronic communication network, such as Internet, for transferring information, so as to allow widespread and convenient application of the present invention by a wide range of users.

Another object of the present invention is to provide a verified personal credit search system and a method thereof which are easy to use and interactive in nature so as to facilitate widespread application of the present invention.

Accordingly, in order to accomplish the above objects, the present invention provides a verified personal credit search system, comprising:

a personal database for storing a plurality of personal records of candidates, wherein each of the personal records contains a plurality of personal qualities;

a credit terminal which comprises a credit database linked to the personal database for updating personal credits of the candidates respectively through a communication network, wherein the credit terminal receives each of the personal credits provided by a person related to the respective candidate for verifying an acknowledgment thereof as a personal reference; and

an enquiring station linked to the personal database, wherein when a search query is submitted to the enquiring station to match with one of the personal qualities in the personal database, a search result is generated to verify the personal record with corresponding the personal credits.

Moreover, the present invention also provides a method of verifying personal credits, comprising the steps of:

(a) storing a plurality of personal records of candidates in a personal database, wherein each of the personal records contains a plurality of personal qualities;

(b) updating personal credits of the candidates respectively in a credit database through a communication network, wherein each of the personal credits is provided by a person related to the respective candidate for verifying an acknowledgment thereof as a personal reference;

(c) sorting out the personal records when a search query is submitted to the enquiring station to match with one of the personal qualities in the personal database; and

(d) generating a search result to verify the personal record with corresponding the personal credits.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a verified personal credit search system according to a preferred embodiment of the present invention.

FIG. 2 is a flow diagram of a method of verifying personal credits according to the above preferred embodiment of the present invention.

FIG. 3 is a schematic diagram of a verifying step of the method of verifying personal credits according to the above preferred embodiment of the present invention.

### DETAILED DESCRIPTION OF THE PREFERRED EMBODIMENT

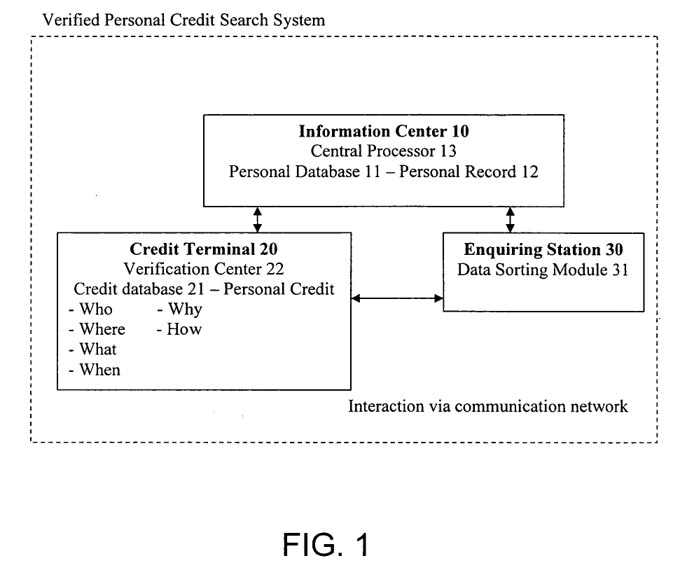

Referring to FIG. 1 of the drawings, a verified personal credit search system according to a preferred embodiment of the present invention is illustrated, in which the verified personal credit search system comprises an information center 10, a credit terminal 20, and an enquiring station 30.

The information center 10 comprises a personal database 11 for storing personal records 12 for candidates respectively, wherein each of the personal records 12 contains one or more personal qualities detailing the personal information of the respective candidate. According to the present invention, the terminology “person”, “personal” or “candidate” refers to an independent human being or entity.

The credit terminal 20 comprises a credit database 21 linked to the personal database 11 of the information center 10 for updating personal credits of the candidates respectively through a communication network, wherein the credit terminal 20 receives each of the personal credits provided a credit provider who is a person relating to the respective candidate for verifying an acknowledgment thereof as a personal reference.

The personal credits of the candidates contain a wide variety of attributes or characteristics peculiar to the respective candidate wherein those attributes or characteristics are verified by the persons relating to the respective candidate (i.e. the credit providers) so that the user of the present invention is capable of gaining an accurate and reliable assessment of the corresponding candidate's credits. For example, the candidates' credits may relate to his/her past work experience or employers' evaluation. Similarly, where the candidate is an independent contractor, the candidate's credits may take the form of the candidate's past performance or assessment of his/her any malpractice or unprofessional behavior. Of course, where the candidate's performance is superb in quality, the candidate's credits may record the corresponding praise or assessment.

More specifically with regard to the preferred embodiment of the present invention, the personal credits stored in the credit database 21 for the respective candidate are derived from the acknowledgment in association with ‘Who’, ‘Where’, ‘What’, ‘When’, ‘Why’ and ‘How’ provided by the relative credit provider(s) of the respective candidate, in which “Who” referring to the identity of the candidate, ‘Where’ referring to the place at which interaction between the candidate and the credit provider took place, ‘What’ referring to the event of interaction or the effort of any project or previous performance, and ‘When’ referring to the time at which the interaction took place, ‘Why referring to the aim of the project or previous performance of the candidate, and ‘How’ referring to the tools used in the interaction between the candidate and the credit provider.

In other words, the personal credits for each of the candidates are not inputted by the candidates themselves but are inputted into the credit databases by a third party, the credit provider, who may act as a referee for providing reliable credential information about a wide variety of attributes of the respective candidate and such credential information is in fact verified by the qualified service provider relative to the respective candidate at the time being provided by the credit provider through the credit terminal.

Also, the acknowledgement provided by the relative credit provider(s) of the respective candidate can be fact pattern, in association with ‘Who’, ‘Where’, ‘What’, ‘When’, ‘Why’ or ‘How’ or a combination of any of the ‘Who’, ‘Where’, ‘What’, ‘When’, ‘Why’ or ‘How’, of an interactive event performed between the respective candidate and the service provider. The credit terminal can provide a website with preprogrammed questionnaires for the credit providers to log on and fill in information and/or acknowledgement regarding the specific interactive event between the credit provider and the respective candidate, wherein the inputted information by the credit providers will be formatted and arranged to form the personal credits in the credit database.

For example, person A who is a director engaged with a music producer, person B, in a MTV production in Hollywood in May, 2005. After the MTV production, both persons A and B can input acknowledgements in association with ‘Who’, ‘Where’, ‘What’, ‘When’, ‘Why’ and/or ‘How’ of such interactive event as the personal credits to the other party in the credit database. In other words, person A can provide praise or assessment for person B in the MTV production, wherein person A becomes the credit provider of person B, the candidate. Similarly, person B can also provide praise or assessment for person A in the MTV production, wherein person A becomes the candidate and person B is the credit provider for person A.

For example, company A who is an employer employed an individual B from January 1995 to December 1997 in Los Angeles as a research and development engineer. Both company A and individual B can input acknowledgements in association with ‘Who’, ‘Where’, ‘What’, ‘When’, ‘Why’ and/or ‘How’ of such employment as the personal credits to the other party in the credit database. In other words, company A can provide praise or assessment and/or verified such employment and performance for individual B, wherein company A becomes the credit provider of individual B, the candidate. Similarly, individual B can also provide praise or assessment for company A in the employment to claim whether the company A is a quality employer providing for example reasonable care to employees, wherein the company A becomes the candidate and the individual B is the credit provider for the company A.

The enquiring station 30 is linked to the information center 10, wherein when a search query is submitted to the enquiring station 30 to match with one of the personal qualities in the personal database 11, a search result is generated to report the personal record with the corresponding personal credits. In other words, the search result signifies that the personal credits of the personal record of the respective candidate has been verified by the relevant credit provider in order to ensure maximum reliability of the personal credits.

According to the preferred embodiment of the present invention, the information center 10, the credit terminal 20 and the enquiring station 30 are computer-assisted so that the personal database 11 and the credit database 21 are stored in a computerized medium, such as a hard disk, for rapid and accurate sorting or retrieval. Alternatively, the information center 10, the credit terminal 20 and the enquiring station 30 may be implemented on other appropriate mediums so as to achieve the above-mentioned objects.

According to the preferred embodiment of the present invention, the credit terminal 20 further comprises a verification center 22 which is linked to the credit database 21 and arranged for receiving a certification message from the credit providers through the communication network to generate a certified notice in the search result so as to certify the personal credits from the credit provider after receiving the personal credits with respect to the candidate. Accordingly, the verification center 22 will generate an uncertified notice in the search result for the personal credits when the verification center 22 does not receive the certification message from the relevant credit providers.

In order to provide creditability of the information provided by the credit provider, the information center 10 provides an identifying code as one of the personal qualities for each of the candidates that the identifying code is adapted to be released to the credit provider in order to access the credit database for updating the personal credits of the respective candidate through the communication network.

The enquiring station 30 comprises a data sorting module 31 sorting out the personal records with respect to the search query submitted to the enquiring station 30 so as to generate the search result in association with the acknowledgment to be updated and previewed.

A searcher or user may search for personal credits of a specific party or any individuals or entities containing specific personal credits through the enquiring station 30. For example, the searcher may submit a search query of an identity of an individual. If any personal record of a candidate in the personal database matches the search query, the personal credits in the credit database with respect to the candidate is sorted out and reported in a search report to the user. Or, for example, the user wants to employ a male Jazz guitar musician to play with his band in his restaurant located in Los Angeles city at night from 7:00pm to 10:00pm for every weekend. The user may enter a search query in terms of ‘Who’, ‘Where’, ‘What’, ‘When’, ‘Why’ and/or ‘How’, i.e. “Male Musician”, “restaurant in Los Angeles”, “play with a band”, “7:00pm to 10:00pm every weekend”, “contacted employment”, and/or “Jazz guitar” respectively. Candidates with such experiences or historical performances that are stored as personal credits in the credit database will be sorted out and provided in the search report.

In addition, the information center 10 further comprises a central processor 13 electrically linked with the personal database 11 to co-ordinate and control the activities of the entire verified personal credit search system. For instances, the central processor 13 may be embodied as a CPU of a typical computer system for processing the search query and for supervising an overall operation of the present invention.

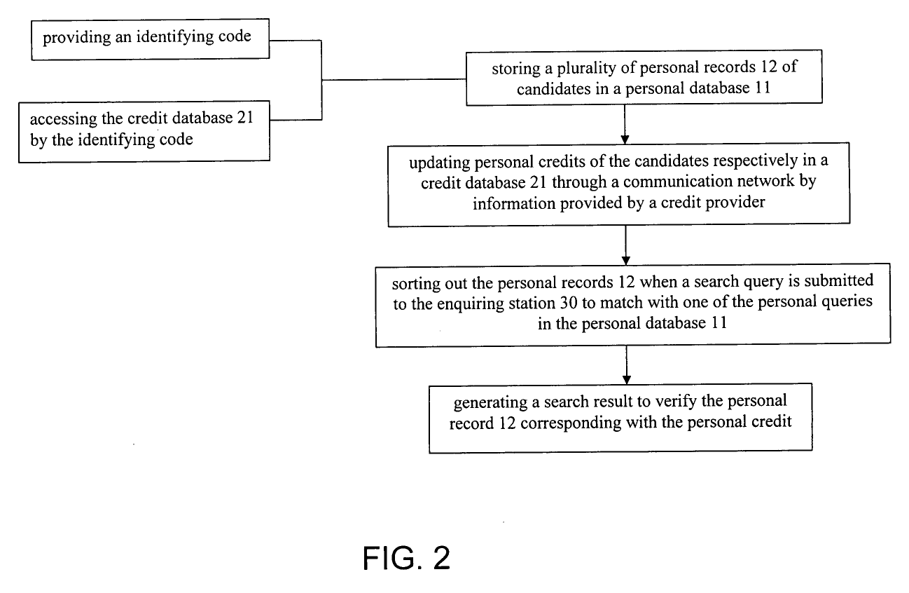

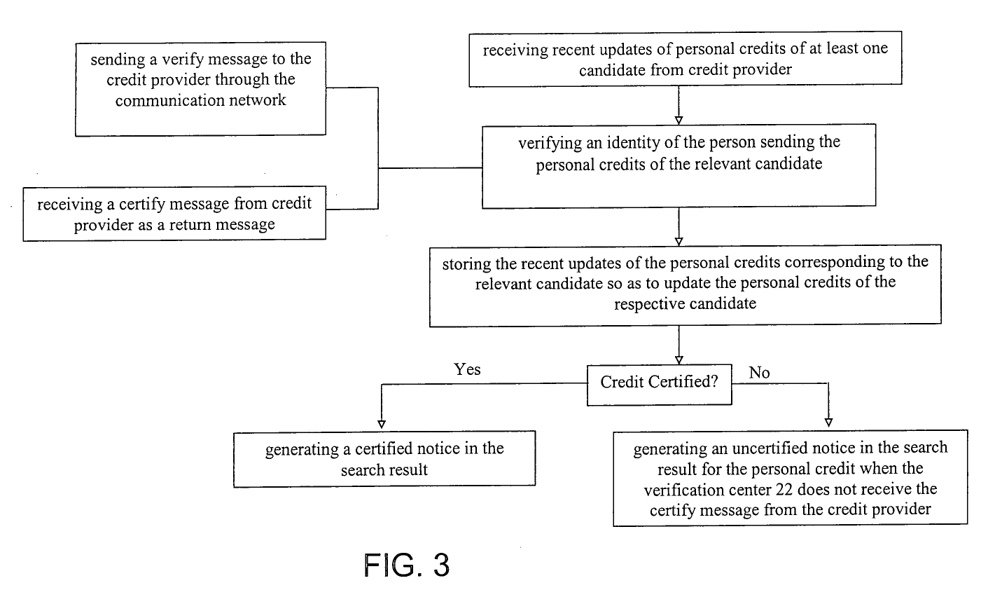

Referring to FIG. 2 to FIG. 3 of the drawings, a method of verifying personal credits according to a preferred embodiment of the present invention is illustrated, in which the method comprises the steps of:

(a) storing a plurality of personal records of candidates in a personal database 11, wherein each of the personal records 12 contains a plurality of personal qualities;

(b) updating personal credits of the candidates respectively in a credit database 21 through a communication network, wherein each of the personal credits is provided by a person related to the respective candidate (credit provider) for verifying an acknowledgment thereof;

(c) sorting out the personal records 12 when a search query is submitted to the enquiring station 30 to match with one of the personal qualities in the personal database 11; and

(d) generating a search result to verify the personal record 12 corresponding with the personal credits.

In step (a), the personal qualities of the personal records 12 contain personal information of the corresponding candidate so as to clarify the identity of the corresponding candidate in the personal database 10. For example, the personal information of candidates should be information capable of characterizing the identity of the candidates which may include but not limited to the respective candidate's name, age, address, driver license number, social security number, passport number, biography, and etc. More specifically, as mentioned earlier, the personal credits stored in the credit database 21 for the respective candidate are derived from the acknowledgment in association with “Who”, “Where”, “What”, “When”, ‘Why’ and ‘How’ provided by the relative credit provider(s) of the respective candidate.

Step (a) comprises the steps of:

(a.1) providing an identifying code as one of the personal qualities for each of the candidates that the identifying code is adapted to be released from the candidate to the respective credit providers; and

(a.2) accessing the credit database 21 by the identifying code to update the personal credits of the respective candidate through the communication network.

In order to verify an identity of the relevant credit providers so as to ensure maximum reliability of the information provided by the credit provider, step (b) further comprises the steps of:

(b.1) receiving recent updates of personal credits of at least one candidate stored in the credit database 21 from the person relating to the respective candidate;

(b.2) verifying an identity of the person sending the personal credits of the relevant candidate; and

(b.3) storing the recent updates of the personal credits corresponding to the relevant candidate so as to update the personal credits of the respective candidate.

Step (b.2) further comprises the steps of:

(b.2.1) sending a verification message to the credit provider through the communication network when the credit terminal 20 receives the personal credits of the respective candidate;

(b.2.2) receiving a certification message from credit provider as a return message of the verification message from the credit provider in a verifying center 22; and

(b.2.3) generating a certified notice in the search result for the personal credits to certify the personal credits from the credit provider.

Moreover, step (b) further comprises a sub-step of:

(b.3′) generating an uncertified notice in the search result for the personal credits when the verification center 22 does not receive the certification message from the credit provider.

It is of overriding importance to verify the identities of the persons giving the personal credits (i.e. credit providers) so as to maintain the maximum reliability and authoritative status of the information of the present invention, so that any user accessing the verified personal credit search system can be fully confident of the background of the persons giving the personal credits. This can be accomplished by ID verification wherein each credit provider is given a reference identification key to gain access to the credit database 21 and input the corresponding personal credits. In other words, step (b) further comprises a step of validating an identity of the relevant credit provider by checking a reference identification key assigned to the corresponding credit provider so that a true identity of the person providing or updating the corresponding personal credits in the credit database 21 can be assured. The reference identification key, which is unique for each credit provider, is given to him/her when he/she fist registers with the verified personal credit search system of the present invention.

In step (c), the search query is preferably submitted via an electronic communication network such as an Internet. Consequently, the method of verifying personal credits further comprises a step of setting up an interactive interface for a user to visualize his/her submission of search query and to obtain the search result in a visible form. For example, the interactive interface may be embodied as a specifically designed webpage which is accessible by the users of the present invention as well as by the candidates for updating their personal information in the personal database 10.

Step (d) comprises the steps of:

(d.1) extracting the personal credits which match with the search query submitted via the enquiring station 30;

(d.2) sorting the personal credits which match with the search query in the information center 10; and

(d.3) visually displaying the search result via the interactive interface.

From the forgoing descriptions, it is observable that the method of verifying personal credits may be subscribed by eligible persons, such as the users or the candidates. The eligible persons are then given permission to submit their credits information or personal information. As such, the confidentiality of the information concerned can be assured. Moreover, since the relevant information, such as the personal credits, can be strictly confidential, and may only be given by limited categories of persons having the relevant permission, users of the present invention can be confident that the information contained in the personal credits search system and the method of the present invention is of maximum reliability and accuracy.

Thus, it can be shown that the search system of the present invention will receive recent updates of personal credits of at least one candidate stored in the credit database from the credit provider. The information will be verified and stored in the credit database 21 for future retrieval.

It is worth mentioning that instead of utilizing direct Internet communication between the information center 10 with the users or the persons providing the personal credits, the communication may also be taken place by emails such that, for example, the search results are given by emails sent to specifically assigned addresses.

The operation of the present invention can be very board. First, a user of the present invention may utilize the search system as disclosed above to look for a suitable independent contractor who has been given credits by some credit providers. The credit providers may be the independent contractor's previous customers who have provided credits for that contractor.

Alternatively, the present invention may be utilized in human resources application. For example, a potential employer may log on to the search system and look for previous employment performance of the candidate. Furthermore, when an employee quits a particular post, he/she may request his/her employer to submit credits information to the information center 10 for updating the credit database 21 of the credit terminal 20.

From the forgoing descriptions, it can be shown that the above objects have been substantially accomplished. The present invention provides verified personal credit search system and a method thereof which enables a user to obtain or confirm the personal credits of a candidate so as to assist the user in making accurate decisions in the course of a wide variety of business dealings.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A personal credit search system, comprising:
a personal database for storing a plurality of personal records of candidates, wherein each of said personal records contains a plurality of personal qualities;
a credit database linked to said personal database for updating personal credits of said candidates respectively through a communication network, wherein each of said personal credits provided by a person related to said respective candidate as a credit provider for verifying an acknowledgment thereof as a personal reference; and
an enquiring station linked to said personal database, wherein when a search query is submitted to said enquiring station to match with one of said personal qualities in said personal database, a search result is generated to report said personal record corresponding with said personal credits of said credit database.

2. The personal credit search system, as recited in claim 1, comprising a credit terminal comprising said credit database and a verification center which is linked to said credit database and arranged for receiving a certification message from said credit provider through said communication network to generate a certified notice in said search result so as to certify said personal credits from said credit provider after receiving said personal credits with respect to said candidate.

3. The personal credit search system, as recited in claim 2, wherein said verification center generates an uncertified notice in said search result for said personal credits when said verification center does not receive said certification message from said credit provider.

4. The personal credit search system, as recited in claim 1, wherein said personal credits stored in said credit database for said respective candidate are derived from said acknowledgment in association with “Who”, “Where”, “What”, “When”, “Why” and “How” provided by one of more of said credit providers related to said respective candidate, said “Who” referring to an identity of said candidate, said ‘Where’ referring to a place at which interaction between said candidate and said credit provider takes place, said ‘What’ referring to an effort of previous performance of said candidate, said ‘When’ referring to the time at which said interaction takes place, said “Why” referring to an aim of said previous performance of said candidate, and said ‘How’ referring to tools used in said interaction between said candidate and said credit provider.

5. The personal credit search system, as recited in claim 2, wherein said personal credits stored in said credit database for said respective candidate are derived from said acknowledgment in association with “Who”, “Where”, “What”, “When”, “Why” and “How” provided by one of more of said credit providers related to said respective candidate, said “Who” referring to an identity of said candidate, said ‘Where’ referring to a place at which interaction between said candidate and said credit provider takes place, said ‘What’ referring to an effort of previous performance of said candidate, said ‘When’ referring to the time at which said interaction takes place, said “Why” referring to an aim of said previous performance of said candidate, and said ‘How’ referring to tools used in said interaction between said candidate and said credit provider

6. The personal credit search system, as recited in claim 1, comprising an information center which comprises said personal database and provides an identifying code as one of said personal qualities for each of said candidates that said identifying code is adapted to be released to said credit provider in order to access said credit database for updating said personal credits of said respective candidate through said communication network.

7. The personal credit search system, as recited in claim 2, comprising an information center which comprises said personal database and provides an identifying code as one of said personal qualities for each of said candidates that said identifying code is adapted to be released to said credit provider in order to access said credit database for updating said personal credits of said respective candidate through said communication network.

8. The personal credit search system, as recited in claim 5, comprising an information center which comprises said personal database and provides an identifying code as one of said personal qualities for each of said candidates that said identifying code is adapted to be released to said credit provider in order to access said credit database for updating said personal credits of said respective candidate through said communication network.

9. The personal credit search system, as recited in claim 1, wherein said enquiring station comprises a data sorting module sorting out said personal records with respect to said search query submitted to said enquiring station so as to generate said search result in association with said acknowledgment to be updated and previewed.

10. The personal credit search system, as recited in claim 5, wherein said enquiring station comprises a data sorting module sorting out said personal records with respect to said search query submitted to said enquiring station so as to generate said search result in association with said acknowledgment to be updated and previewed.

11. The personal credit search system, as recited in claim 8, wherein said enquiring station comprises a data sorting module sorting out said personal records with respect to said search query submitted to said enquiring station so as to generate said search result in association with said acknowledgment to be updated and previewed.

12. The personal credit search system, as recited in claim 1, wherein said personal database is contained in an information center and said credit database is contained in a credit terminal, wherein said information center, said credit terminal and said enquiring station are computer-assisted so that said personal database and said credit database are stored in a computerized medium for rapid and accurate sorting and retrieval through said communication network.

13. The personal credit search system, as recited in claim 8, wherein said information center, said credit terminal and said enquiring station are computer-assisted so that said personal database and said credit database are stored in a computerized medium for rapid and accurate sorting and retrieval through said communication network.

14. The personal credit search system, as recited in claim 11, wherein said information center, said credit terminal and said enquiring station are computer-assisted so that said personal database and said credit database are stored in a computerized medium for rapid and accurate sorting and retrieval through said communication network.

15. A personal credit searching method, comprising the steps of:
(a) storing a plurality of personal records of candidates in a personal database, wherein each of said personal records contains a plurality of personal qualities;
(b) updating personal credits of said candidates respectively in a credit database through a communication network, wherein each of said personal credits is provided by a credit provider who is a person related to said respective candidate for verifying an acknowledgment thereof as a personal reference;
(c) sorting out said personal records upon a search query to match with one of said personal qualities in said personal database; and
(d) generating a search result to verify said personal record corresponding with said personal credits.

16. The method, as recited in claim 15, in step (b), further comprising the steps of:
sending a verification message to said credit provider through said communication network upon receiving said personal credits of said respective candidate;
receiving a certification message from said credit provider as a return message of said verification message from said credit provider; and
generating a certified notice in said search result for said personal credits to certify said personal credits from said credit provider.

17. The method, as recited in claim 16, in the step (b), further comprising a step of generating an uncertified notice in said search result for said personal credits when said certification message from said credit provider is not received.

18. The method, as recited in claim 17, wherein the step (b) further comprises a step of validating an identity of said credit provider by checking a reference identification key assigned to said respective credit provider so that a true identity of said credit provider is assured by said reference identification key.

19. The method, as recited in claim 15, in the step (a), further comprising the steps of:
(a.1) providing an identifying code as one of said personal qualities for each of said candidates that said identifying code is adapted to be released from said candidate to said respective credit provider; and
(a.2) accessing said credit database by said identifying code to update said personal credits of said respective candidate through said communication network.

20. The method, as recited in claim 17, in the step (a), further comprising the steps of:
(a.1) providing an identifying code as one of said personal qualities for each of said candidates that said identifying code is adapted to be released from said candidate to said respective credit provider; and
(a.2) accessing said credit database by said identifying code to update said personal credits of said respective candidate through said communication network.

21. The method, as recited in claim 15, wherein said personal credits stored in said credit database for said respective candidate are derived from said acknowledgment in association with ‘Who’, ‘Where’, ‘What’, ‘When’, ‘Why’ and ‘How’ provided by one or more said credit providers related to said respective candidate, said ‘Who’ referring to an identity of said candidate, said ‘Where’ referring to a place at which interaction between said candidate and said credit provider takes place, said ‘What’ referring to an effort of previous performance of said candidate, said ‘When’ referring to the time at which said interaction takes place, said ‘Why’ referring to an aim of said previous performance of said candidate, and said ‘How’ referring to tools used in said interaction between said candidate and said credit provider.

22. The method, as recited in claim 17, wherein said personal credits stored in said credit database for said respective candidate are derived from said acknowledgment in association with ‘Who’, ‘Where’, ‘What’, ‘When’, ‘Why’ and ‘How’ provided by one or more said credit providers related to said respective candidate, said ‘Who’ referring to an identity of said candidate, said ‘Where’ referring to a place at which interaction between said candidate and said credit provider takes place, said ‘What’ referring to an effort of previous performance of said candidate, said ‘When’ referring to the time at which said interaction takes place, said ‘Why’ referring to an aim of said previous performance of said candidate, and said ‘How’ referring to tools used in said interaction between said candidate and said credit provider.

23. The method, as recited in claim 20, wherein said personal credits stored in said credit database for said respective candidate are derived from said acknowledgment in association with ‘Who’, ‘Where’, ‘What’, ‘When’, ‘Why’ and ‘How’ provided by one or more said credit providers related to said respective candidate, said ‘Who’ referring to an identity of said candidate, said ‘Where’ referring to a place at which interaction between said candidate and said credit provider takes place, said ‘What’ referring to an effort of previous performance of said candidate, said ‘When’ referring to the time at which said interaction takes place, said ‘Why’ referring to an aim of said previous performance of said candidate, and said ‘How’ referring to tools used in said interaction between said candidate and said credit provider.

24. The method, as recited in claim 15, wherein said personal database is contained in an information center, said credit database is contained in a credit terminal, and said search query is performed at an enquiring station, wherein said information center, said credit terminal and said enquiring station are computer-assisted so that said personal database and said credit database are stored in a computerized medium for sorting and retrieval through said communication network.

25. The method, as recited in claim 20, wherein said personal database is contained in an information center, said credit database is contained in a credit terminal, and said search query is performed at an enquiring station, wherein said information center, said credit terminal and said enquiring station are computer-assisted so that said personal database and said credit database are stored in a computerized medium for sorting and retrieval through said communication network.

26. The method, as recited in claim 23, wherein said personal database is contained in an information center, said credit database is contained in a credit terminal, and said search query is performed at an enquiring station, wherein said information center, said credit terminal and said enquiring station are computer-assisted so that said personal database and said credit database are stored in a computerized medium for sorting and retrieval through said communication network.
